(19) United States
(12) Patent Application Publication
(10) Pub. No.: US 2004/0187266 A1
(43) Pub. Date: Sep. 30, 2004

(54) Reusable pivotable paint brush handle assembly

(76) Inventor: Anthony Garner, Philadelphia, PA (US)

Correspondence Address: SUSAN BORDEN EVANS, EVANS & BORDEN EVANS, 2043 WALNUT STREET, PHILADELPHIA, PA, 19103, US

(21) Appl. No.: 10/400,315

(22) Filed: Mar. 26, 2003

(51) Int. Cl. E05B 1/00

(52) U.S. Cl. 16/438

(57) ABSTRACT

Disclosed herein is a paint brush which includes a locking screw at the base of its handle, which allows the brush to pivot unrestricted from side to side allowing the brush to engage and lock at any of a continuity of angles along the axis of the handle.

### BACKGROUND

The present invention relates to a paint brush handle assembly, which includes a locking screw at the base of its handle, which allows the brush head to pivot from side to side.

Paint brushes and similarly designed brushes follow one general construction. This conventional construction consists of a handle with a stationary head. This conventional structure is very limiting in the angles that it can easily reach. Thus it is difficult to paint, in many instances causing the painter himself to engage his body in contorted and often dangerous ways to paint inaccessible areas.

The present invention is constructed to alleviate this problem. The present construction consists of a handle element and a separate brush element connected by a locking screw. This construction facilitates the brush element in pivoting from side to side up to about a 180 degree angle. The previous attempts to alleviate this problem have attained various angles and a swivel action but require the user to manually twist a thumb nut or wing nut to attain a new position. This creates an awkward and messy situation during the painting process, requiring the user to manually manipulate this thumb nut during the painting process. Another limitation of the prior art is that the rotation of the brush is restricted to a “predetermined number of angles”. This construction also has a number of parts which parts often get clogged with paint. Further, this prior art is generally too complicated for the ease of use that most painters require.

The simple construction of the paint brush handle assembly of this invention successfully overcomes the above problems by providing an improved brush construction with few parts. The parts include a pivotable handle which allows for a side to side motion utilizing a locking screw. The locking screw of the present invention may easily be manipulated with a screwdriver, a standard tool of painters, thus preventing painters' hands from contacting wet paint.

Various brushes with moveable components are known in the art. One such patent discloses a paint brush with a disposable brush head which is able to pivot to a number of predetermined angular positions with respect to the axis of its handle. See U.S. Pat. No. 6,301,740 B1 (Quiroz). However, the brush of the present invention is not restricted in its movement and is able to engage and lock at any of a continuity of angles along the axis of the handle.

This prior art does not disclose the instant invention.

### SUMMARY OF THE INVENTION

The present invention provides a reusable pivotable paint brush handle assembly comprising a reusable brush element and a handle element, said handle element having a base end and a top end, said brush element having a top and a bristle holder, is pivotably attached to the handle element at its base end by attachment means which allow the brush element to engage and lock at any of a continuity of angles along the axis of the handle element, wherein the attachment means allows the brush element to pivot unrestricted from side to side up to 180 degrees, wherein further the brush element has bristles and said bristles project vertically from the bristle holder of the brush element.

### BRIEF DESCRIPTION OF THE DRAWINGS

These as well as other features of the present invention will become more apparent upon reference to the drawings wherein:

FIG. 1 is a front view of the paint brush handle assembly of the present invention;

FIG. 2 is a side view of the paint brush handle assembly of the present invention;

FIG. 3 is a side view of the paint brush handle assembly of the present invention showing all of the elements disconnected;

FIG. 4A is a front view of the brush element of the paint brush handle assembly of the present invention; and

FIG. 4B is a front view of the handle element of the paint brush handle assembly of the present invention.

### DETAILED DESCRIPTION OF THE INVENTION

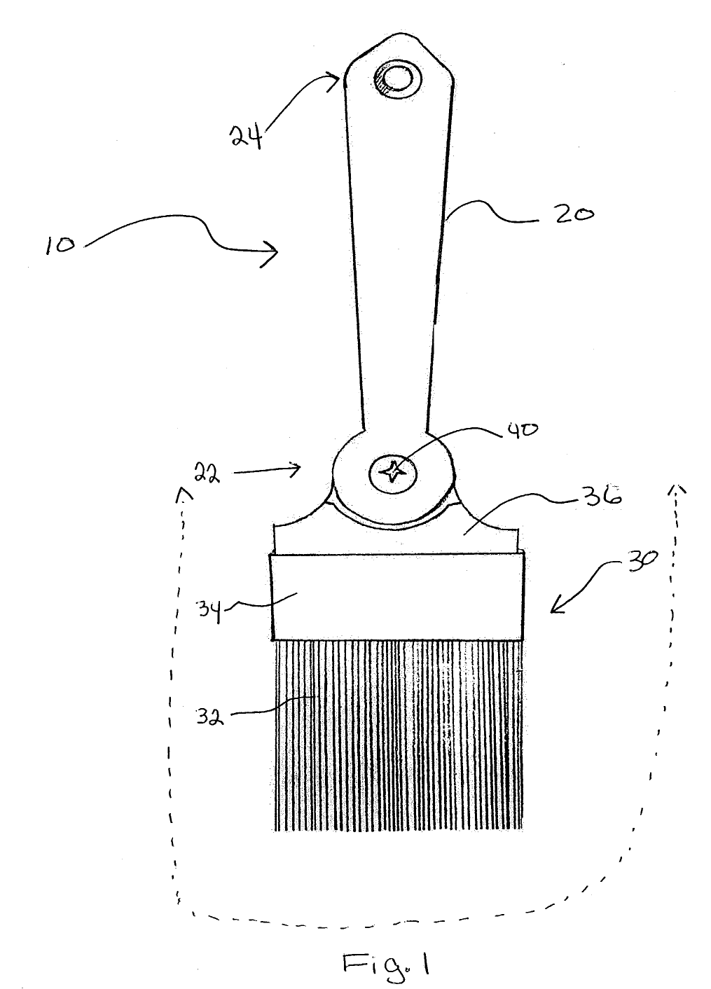

FIGS. 1-4B collectively illustrate the components of the reusable pivotable paint brush handle assembly of the present invention 10. The reusable pivotable brush handle assembly of the present invention 10 comprises a reusable brush element 30 and a handle element 20, said handle element having a base end 22 and a top end 24, wherein said brush element 30 is rotatably attached to the handle element 20 at its base end 22 by attachment means 40, which allows the brush element 30 to engage and lock at any of a continuity of angles along the axis of the handle element 20, wherein the attachment means 40 allows the brush element 30 to pivot unrestricted from side to side up to 180 degrees, wherein further the brush element 30 has bristles and said bristles project vertically from the bristle holder of the brush element 30.

The brush element 30 can pivot up to about 180 degrees, Preferably 5 degrees to 160 degrees, more preferably, 90 to 160 degrees. The brush handle assembly 10 wherein the attachment means 40 is also a locking means 40 which locks the brush element 30 in place at any angle on the continuity of angles along the axis of the handle element 20. The attachment means 40 is selected from the group consisting of a locking screw 41 and a pressure screw, preferably a locking screw. These screws are well known in the art and easily attainable at any hardware store. The locking screw 41 and the pressure screw are used to keep the brush element 30 stationary while painting. The locking screw 41 is manipulated, tightened and loosened by using a screw driver which is easily utilized while painting.

Two advantages of this invention are its simplicity and its adaptability. This assembly can be used with almost every paint brush assembly regardless of type of materials used in the manufacture of the brush or handle elements. The screws can either lock this assembly in place and avoid slippage or allow it to conform to any desired angle by adjusting the locking screw 41 with a screw driver or merely applying pressure on the brush element in the painting process.

Although a multitude of brushes could utilize this novel paint brush handle assembly 10 the preferred use of the present invention is the paint brush. The brush element 30 is reusable. It is therefore important that paint does not get caught in moveable aspects of this invention. The present invention has no mechanisms, depressions, ribs or recesses to clog with paint and defeat its advantages. It is a smooth, simplistic, economical and easy to use device.

FIG. 1 depicts a front view of the paint brush handle assembly 10 of the present invention. It shows each of the principal elements of the invention including the handle 20, the handle base end 22 and top end 24, the brush element 30 which includes the bristles 32, the bristle holder 34, the top 36 of the brush element 30 which attaches by attachment means 40 to the base end 22 of the handle element 20. The pivot directions are also indicated which show that the brush element 30 pivots up to about 180 degrees.

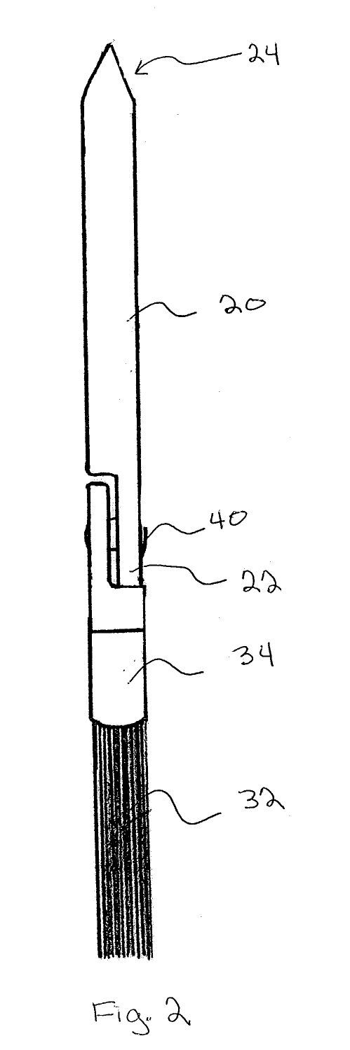

FIG. 2 depicts a side view of the paint brush handle assembly 10 of the present invention.

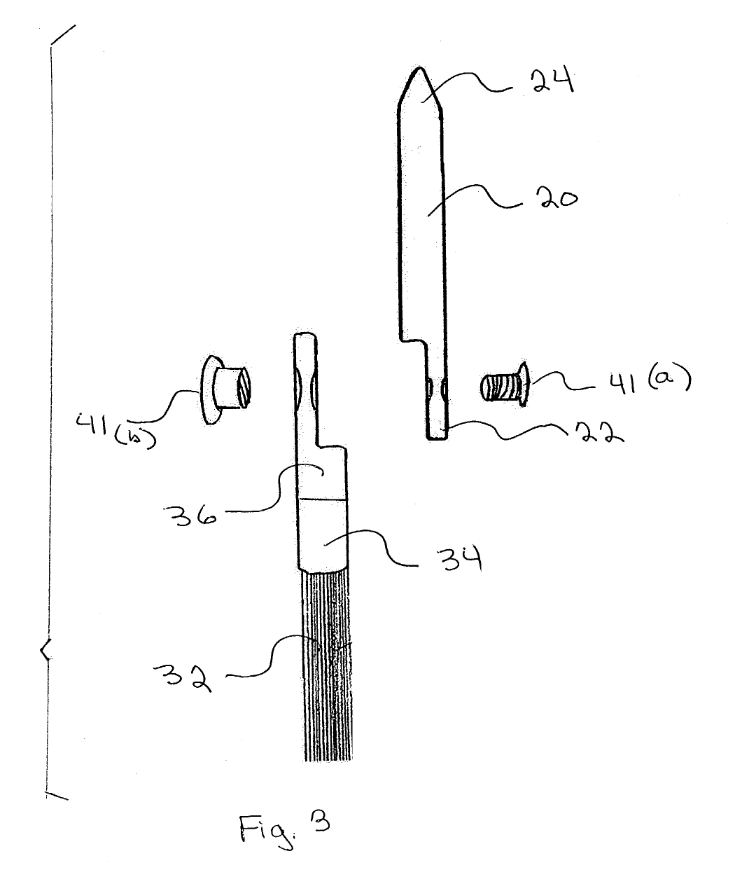

FIG. 3 depicts a side view of the paint brush handle assembly 10 of the present invention showing all of the elements disconnected. Attachment means 40, locking screw parts (screw 41(a) and connecting cap nut 41(b)) are visible. Significant attributes of this invention are its simplicity, affordability and ease of use for painters.

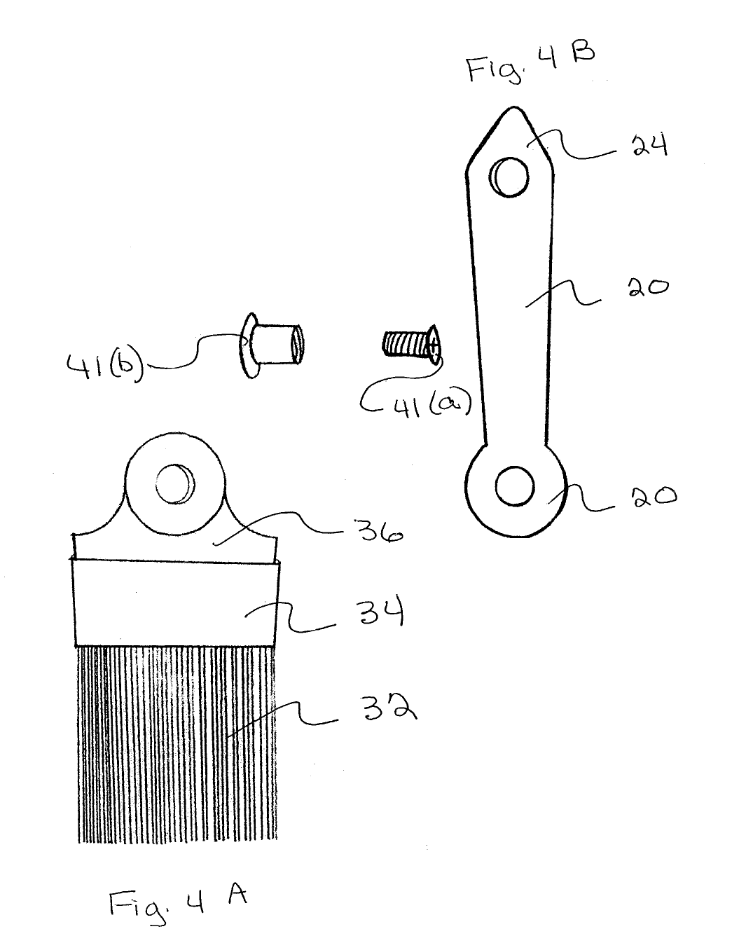

FIG. 4A depicts a front view of the brush element 30 of the paint brush handle assembly 10 of the present invention.

FIG. 4B depicts a front view of the handle element 20 of the paint brush handle assembly 10 of the present invention.

Changes and modifications in the specifically described embodiments can be carried out without departing from the scope of the invention which is intended to be limited only by the scope of the appended claims.

What is claimed:

1. A paint brush handle assembly comprising a reusable brush element and a handle element, said handle element having a base end and a top end, said brush element having a top and a bristle holder is pivotably attached to the handle element at its base end by attachment means, which allow the brush element to engage and lock at any of a continuity of angles along the axis of the handle element, wherein the attachment means allows the brush element to pivot unrestricted from side to side up to 180 degrees, wherein further the brush element has bristles and said bristles project vertically from the bristle holder of the brush element.

2. A paint brush handle assembly according to claim 1 wherein the brush element pivots from 5 degrees up to about 160 degrees.

3. A paint brush handle assembly according to claim 2 wherein the brush element pivots from about 91 degrees up to about 160 degrees.

4. A paint brush handle assembly according to claim 1 wherein the attachment means is a locking means to lock the handle element in place at any angle on the continuity of angles along the axis of the handle element.

5. A paint brush handle assembly of claim 4 wherein the attachment means is selected from the group consisting of a locking screw and a pressure screw.

6. A paint brush handle assembly of claim 5 wherein the attachment means is manipulated by a screw driver.

7. A paint brush handle assembly of claim 6 wherein the attachment means is a locking screw.

8. A paint brush handle assembly of claim 6 wherein the attachment means is a pressure screw.
